(19) United States
(12) Patent Application Publication
(10) Pub. No.: US 2013/0013374 A1
(43) Pub. Date: Jan. 10, 2013

(54) RELATIONSHIP PRICING MEASUREMENT FRAMEWORK

(75) Inventors: Carol A. Smith, North Palm Peach, FL (US); Michael D. Hutchens, Woodland Hills, CA (US); Adrian P. Cherry, Charlotte, NC (US); Nikolaos Pavlou, Hermosa Beach, CA (US); Nicholas Felton, Charlotte, NC (US)

(73) Assignee: Bank of America, Charlotte, NC (US)

(21) Appl. No.: 13/177,667

(22) Filed: Jul. 7, 2011

(51) Int. Cl. G06Q 30/02

(52) U.S. Cl. 705/7.33

(57) ABSTRACT

Apparatus for providing hypotheses prioritization and analysis are provided. The apparatus may include an electronic processor module. The electronic processor module may be configured to calculate enterprise-wide exposure to a plurality of entities. The plurality of entities may include countries, other enterprises, interest rates and/or other financial statistics. The electronic processor modulo may be further configured to determine, with respect to a single one or more of the plurality of entities, at least one of a market risk metric, a value at risk metric, an issuer risk metric, a counterparty risk metric and a financial risk metric. The apparatus may further include an output device configured to output a risk value reflective of the at least one of a market risk metric, a value at risk metric, an issuer risk metric, a counterparty risk metric and a financial risk metric.

### FIELD OF TECHNOLOGY

Aspects of the disclosure relate to providing apparatus and methods for prioritizing and evaluating hypotheses.

### BACKGROUND

Many relatively large enterprises do not currently prioritize various hypotheses that relate to future business opportunities. Typically, such hypotheses are received and catalogued on a first in, first out basis. In such conventional processes, a hypothesis may be taken out of order only on an ad hoc basis.

It would be desirable, therefore, to provide apparatus and methods that prioritize the review of hypotheses by business enterprises.

It would be further desirable to provide apparatus and methods for evaluating hypotheses according to predetermined evaluation criteria.

### SUMMARY OF THE INVENTION

Apparatus for prioritizing and evaluating hypotheses is provided. The apparatus may be configured to receive a plurality of criteria relating to characteristics of a hypothesis. The hypothesis may relate to whether customers who pay mortgage payments by ACH perform better than customers who do not pay mortgage payments by ACH. The apparatus may receive a predetermined weight for each of the criteria. The apparatus may further receive a list of relationship segments. The apparatus may determine a value for each of the relationship segments with respect to each of the plurality of criteria. The determination may be based, at least in part, on the predetermined weight for each of the criteria. The apparatus may sum the determined values for each of the relationship segments. The apparatus may also rank each of the relationship segments with respect to one another based on the summing of the determined values for each of the relationship segments.

The criteria may include a plurality of criteria selected from the following criteria: whether the hypothesis relates to an enterprise initiative, whether minimal regulatory barriers exist for the hypothesis, whether the hypothesis is capable of promoting customer relationship deepening, the ease of implementation of the hypothesis, the customer impact of the hypothesis, the volume impact of the hypothesis, the incremental revenue impact of the hypothesis, the sales force impact of the hypothesis, and the impact to capacity of the hypothesis.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus that may be used in accordance with the principles of the invention;

FIG. 2 shows an illustrative hypothesis prioritization tool in accordance with the principles of the invention;

FIG. 3 shows an illustrative relationship analytics flow chart in accordance with the principles of the invention;

FIG. 4 shows an illustrative validation flow chart in accordance with the principles of the invention;

FIG. 5 shows illustrative tables in accordance with the principles of the invention;

FIG. 6 shows illustrative bar charts in accordance with the principles of the invention; and

FIG. 7 shows an illustrative table of relationship criteria with exemplary values in accordance with the principles of the invention.

### DETAILED DESCRIPTION OF THE INVENTION

Apparatus and methods in accordance with the principles of the invention may be used for prioritizing and evaluating hypotheses.

The invention relates more specifically to identifying, prioritizing and integrating financial institution-to-customer relationship deepening analytics into a hypothesis analysis framework. One purpose of this approach is to reward customers for expanding and deepening their relationship with the institution. It should be noted that a portion of the relationship deepening analytics are dedicated to examining the effects of the relationship deepening across various segments of the customer population, referred to herein as “relationship segments.”

A hypothesis may relate to customer behavior in a population of financial institution customers. The behavior may relate to one or more financial institution products or prospective financial institution products. A hypothesis may posit that one or more attributes of a product or a customer predict customer behavior that is favorable for the financial institution. The behavior may be favorable if it deepens the relationship between customers and the financial institution. The behavior may be favorable if it increases financial institution revenue.

If the attribute is deemed to cause a favorable behavior, the financial institution may induce customers to further invest in, or adopt more products that have, the attribute. The attribute may be treated as an independent variable in the context of statistical analysis.

For example, a hypothesis may posit that customer loans that are paid via Mortgage ACH have more favorable CPR, delinquency, recapture, and product deepening behavior (such as “retention”) than customer loans that are not paid via Mortgage ACH.

Table 1 shows illustrative hypothesis attributes and customer behaviors for loan products.

TABLE 1
Illustrative hypothesis attributes and
customer behaviors for loan products.

| Illustrative attribute | Illustrative behavior |
|---|---|
| ACH | Reduced prepayment speed; reduced |
| | delinquency; reduced likelihood of |
| | foreclosure; increased retention |
| Customer Possession of | Increased relationship-deepening behavior |
| Minimum Value of Assets | |
| Customer has “primary | Increased relationship-deepening behavior |
| relationship” with | |
| financial institution | |
| FTHB | Not price-sensitive; relative to non-FTHB: |
| | greater pull-through; greater retention; |
| | greater product deepening |
| FTHB | Relative to non-FTHB: lesser prepayment |
| | speed; lesser delinquency; lesser fore- |
| | closure; greater retention |
| Customer has depth and | Relative to customers without depth or |
| tenure | tenure; lesser price sensitivity; lesser |
| | prepayment speed; lesser delinquency; and |
| | greater retention |
| Customer has REO | Increased relationship-deepening behavior |

The predictiveness of the attribute relative to the behavior may be estimated or modeled using any suitable multivariate analysis approach, such as those associated with ANOVA.

The financial institution may adjust product prices to encourage customers to adopt products that have attributes that lead to favorable behavior. Statistical models of predicted behaviors may be used to predict changes in financial institution revenue that are based on product price changes. For example, the financial institution may conclude that loan products in which payments are made by ACH result in favorable customer behavior. The financial institution may quantify the favorable behavior in economic terms and then use the statistical estimates or models to select a price inducement that increases revenue.

A need exists for a formal process to ensure that all hypotheses, such as hypothetical customer offers, are properly reviewed prior to development. Even in the case where a number of valid hypotheses exist, the methods for identifying the highest priority hypotheses and implementation details may be useful.

Further, a formal process, and an associated indexed hypotheses library, may allow for a more holistic approach to evaluating current hypotheses.

Hypothesis may then be used to select product modifications and new products to offer to customers. The speed of hypothesis review and implementation time, variable contribution margin (“VCM”)—i.e., revenue less variable costs—or other suitable metrics may be used to measure performance of the formal process.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

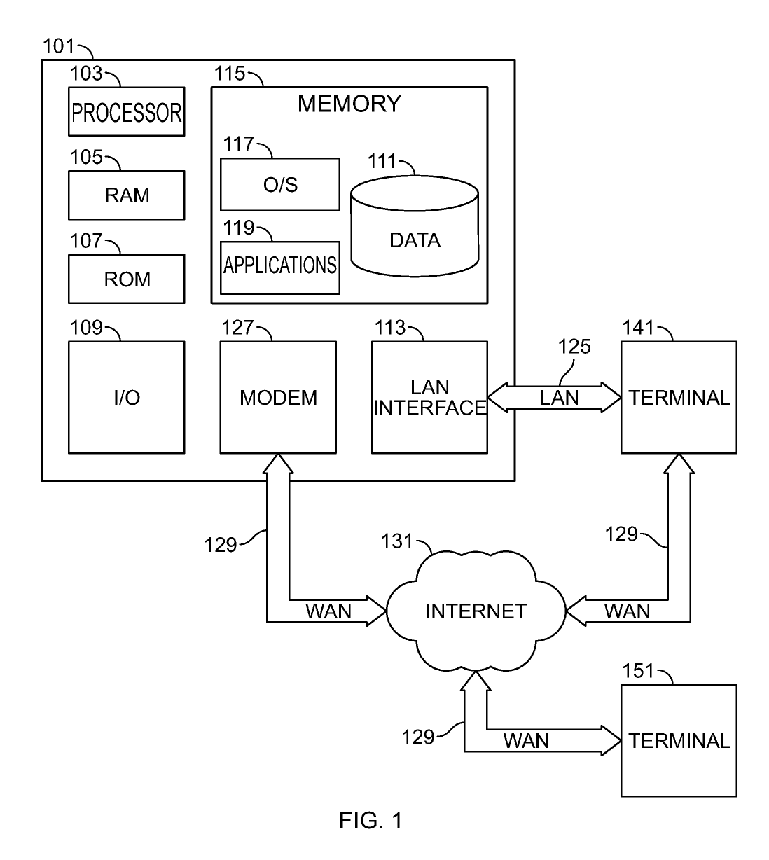

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to transmit and receive entity information, enterprise exposure information and any other suitable information, and perform any other suitable tasks.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown). As described in detail below, database 111 may provide storage for hypotheses, weighting matrices, prioritization, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

Any information described above in connection with database 121, and any other suitable information, may be stored in memory 125.

One or more of applications 119 may include one or more algorithms that may be used to perform one or more of the following: prioritizing and evaluating hypotheses.

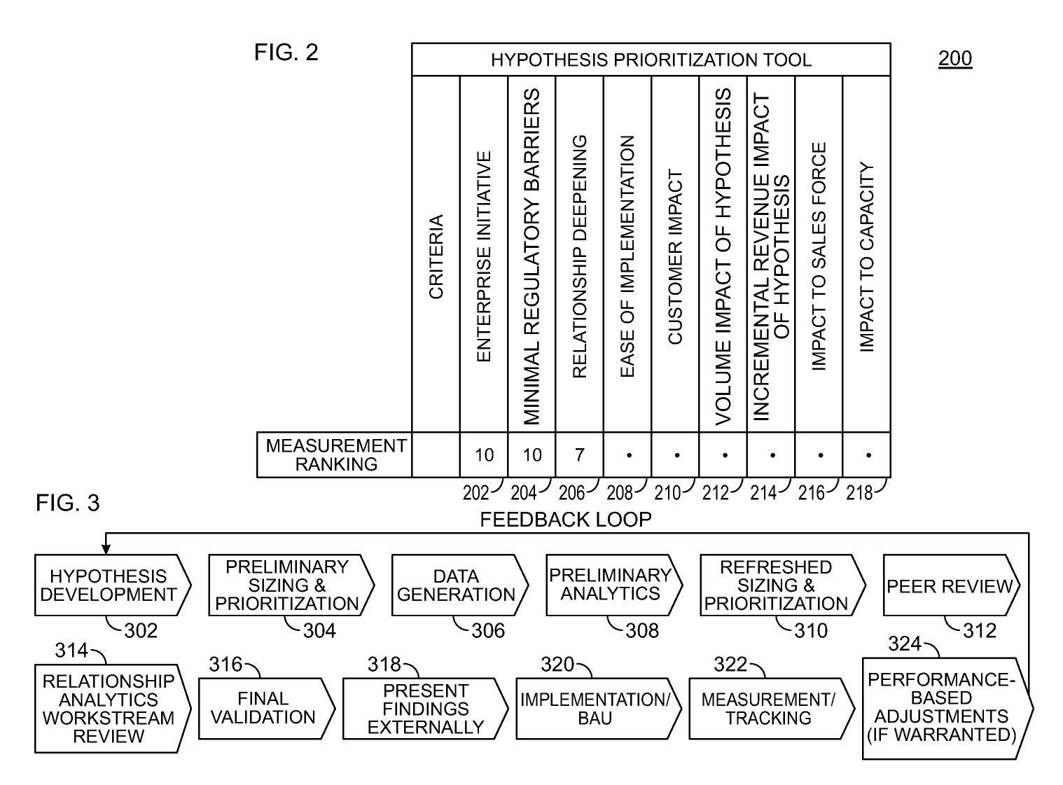

FIG. 2 shows an illustrative hypothesis prioritization tool in accordance with the principles of the invention. The prioritization tool may be used to select hypothesis for testing based on criteria related to the value of the hypothesis to the financial institution. By selecting high-priority hypotheses, the formal process may speed review and implementation time, increase VCM and benefit the institution in other ways. In systems and methods according to the invention, hypotheses may be received at a central location. The hypotheses may be input into a prioritization tool. The prioritization tool may preferably score each hypothesis using metrics and predetermined criteria for ranking each hypothesis.

FIG. 2 sets forth a set of exemplary relationship criteria that may be used in scoring hypotheses. The criteria are elements that impact prioritization of hypothesis analysis. Each criterion is weighted according to its importance using an exemplary 1-10 measurement—e.g., 1=lowest priority, 10=highest. The weights and weighting system are exemplary and any suitable weights and/or weighting system may be used.

The criteria may include whether the hypothesis relates to an enterprise initiative 202, whether minimal regulatory barriers exist for the hypothesis 204, whether the hypothesis 206 is capable of promoting customer relationship deepening 208, the ease of implementation of the hypothesis 210, the customer impact of the hypothesis 212, the volume impact of the hypothesis 214, the incremental revenue impact of the hypothesis 216, the sales force impact 218 of the hypothesis, and the impact to capacity of the hypothesis 220.

FIG. 3 shows an illustrative relationship analytics flow chart in accordance with the principles of the invention. Specifically, FIG. 3 shows a relationship analytics detailed process flow. In certain embodiments, the high level process flow includes selected formalized routines which may be implemented as needed for the execution of the process flow. One purpose of the process flow shown in FIG. 3 may be to support prioritization, and/or implementation of highest value hypotheses in a timely manner.

Step 302 shows hypothesis development according to the invention. Hypotheses that relate to the entity may be received from any suitable source. With respect to a financial services institution, such sources may include groups such as a relationship analytics group, an entity pricing group, a consumer banking group, a marketing group, a product development group or any suitable group.

Step 304 shows preliminary sizing and prioritization of hypotheses. Factors affecting sizing and prioritization of hypotheses may include financial and customer impact, ease of implementation, whether the hypotheses relate to an entity initiative, whether implementation of the hypotheses faces regulatory barriers, whether the hypotheses overlaps any existing projects and/or the availability of data associated with testing and/or implementation of the hypotheses. A hypothesis prioritization tool, such as the tool shown in FIG. 2, may preferably be used in the preliminary sizing and prioritization of hypthoses.

Step 306 shows data generation according to the invention. Such data generation may account for various system dependencies in determining the data output associated with a given hypothesis.

Step 308 shows exemplary preliminary analytics that may be used according to the invention. Such analytics may include analytics performed by finance personnel, accounting personnel and any other personnel who could perform preliminary analytics on the hypotheses.

Step 310 shows refreshed sizing and prioritization of the hypotheses. A prioritization tool for use in such a step may include a mechanism for hypothesis input. Such a tool may also include a mechanism for measuring each hypothesis using preferably pre-determined metrics and metrics ranking.

Step 312 may involve peer review of a prioritized hypothesis. Such peer review may include determining the pricing associated with the subject matter of the hypotheses.

Step 314, which may or may not be dependent on step 312, shows a relationship analytics workstream review. Such a review may include representations regarding the hypotheses. The representations may be received from groups such as marketing, finance, enterprise sales, price elasticity team and/or a pricing counsel.

Step 316 shows a final validation step associated with the final validation of the hypotheses. Such a step may include developing elasticity coefficients for various segments of a customer base.

Step 318 shows an external presentation step.

Step 320 shows an implementation/Business As Usual (“BAU”) step. Such a step may include implementing pricing rules according to relationship segments. Such segments, as described above, may correspond to different socio-economic strata, different occupations, different employers, any combination of the foregoing and/or any other suitably aligned group within the general population.

Step 322 shows measurement tracking according to the invention. Such measurement tracking may include measuring and tracking the implementation of the hypotheses using periodic reporting, identification of key metric trending in order to identify anomalies and/or provide summary reporting.

Finally, step 324 shows using performance-based adjustments, if warranted. Such adjustments may include adjusting elasticity coefficients, adjusting or removing pricing discounts and/or adjusting relative differences according to relationship segments. It should be noted that feedback from step 324 may preferably be looped back to step 302 in order to more finely adjust future hypothesis evaluation and prioritization.

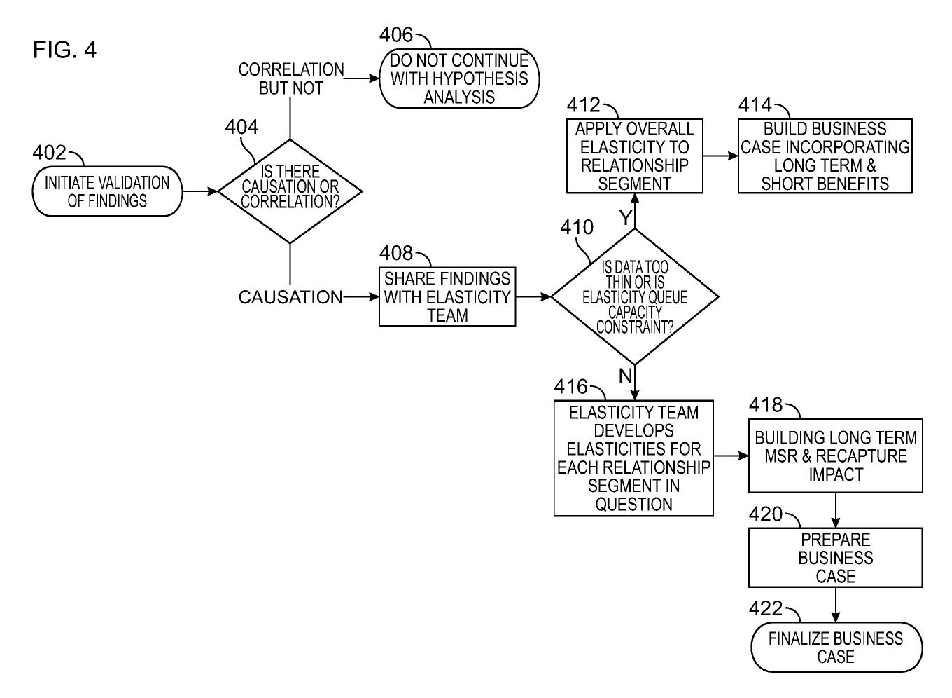

FIG. 4 shows an illustrative final validation flow chart in accordance with the principles of the invention. Step 402 shows performing an initial validation of findings in view of the process shown in FIG. 3. Such an initial validation may include providing an individual loan (or other suitable product) level data set and developing a regression analysis to prove whether relationship segments are causing/driving performance or if there is merely a correlation.

Step 404 shows querying, based on the initial validation findings, whether there is relationship-based causation between the hypothesis and the segments or merely a correlation. Step 406 shows terminating the hypothesis analysis when a correlation, but not a causal connection, is found.

In one exemplary embodiment of systems and methods according to the invention, a logit regression analysis may be performed is used for prediction of the probability of occurrence of a behavior by fitting data to a logit function logistic curve. Like many forms of regression analysis, it may use one or more independent variables that may be either numerical or categorical.

For example, the logit regression may be used to determine whether or not there is a causal relationship between customers paying their mortgage using ACH and loan delinquencies. The purpose of this analysis is to determine whether paying one's mortgage by ACH reduces the tendency of the customer to be delinquent on a loan. The exemplary historical metric to which the future delinquencies are compared against is whether or not the borrower has ever been 90 days or more overdue on a mortgage loan payment. In this particular exemplary analysis, that was the only delinquency data provided in the data file. However, it should be noted that other data may be provided for historical loan delinquency information.

We define the variable:

$${Y}_{i} = \{ \begin{matrix}0 if borrower never 90 + delinquent \\ 1 if borrower has been 90 + delinquent\end{matrix}$$

The modeling for the purpose of predicting whether or not a loan will be 90+ days delinquent in the future is performed via the logit regression, as follows. If X₁, X₂, . . . Xₖ denotes the independent (or predictor) variables in the regression, then, the logit regression fits the following probability function:

$$P ( Y = 0 ) = \frac{exp ( {\sum }_{i = 0}^{k} {β}_{i} {X}_{i} )}{1 + exp ( {\sum }_{i = 0}^{k} {β}_{i} {X}_{i} )} and P ( Y = 1 ) = \frac{1}{1 + exp ( {\sum }_{i = 0}^{k} {β}_{i} {X}_{i} )}$$

where X₀≡1. Based on the foregoing, the systems and methods according so the invention can determine whether the future delinquency has a correlation to the ACH—i.e., there is a relatively high correlation of future delinquency to past delinquency—or future delinquency is causative relative to ACH—i.e., payment by ACH reduces future delinquency substantially independently of historical tendencies towards delinquency. Causation may be based on ruling out LTV, FICA scores, loan type or any other variable that may explain the predicted behavior.

Step 406 shows that, in the event that the relationship aspect of the hypothesis is determined to be correlative to the hypothesis, but not causative, the hypothesis analysis terminates.

While this embodiment uses a logit regression analysis, any suitable analysis may be used to determine whether the hypothesis is correlative to the results or causative.

Step 408 shows that, in the event that the relationship aspect of the hypothesis is determined to be causative, the findings may preferably be shared with an elasticity team.

At step 410, the elasticity team determines whether the data is too thin—i.e., too sparse to be useful as a relationship determinant—or whether the elasticity queue is capacity-constrained—i.e., resources to analyze the elasticity of the hypothesis are non-existent.

If the data is too thin, or the elasticity queue is capacity-constrained, then step 412 shows applying a general, overall, elasticity determination to the relationship segment. Step 414 shows building a business case that incorporates long term and/or short term benefits of the hypothesis.

If the data is sufficient for a unique elasticity determination—i.e., a determination of the supply/demand curve with respect to inducing customers to switch from ACH payment—and the elasticity queue is not capacity constrained, then the elasticity team develops elasticities for each relationship segment in question, at 416.

Independent of whether overall elasticities are used, as shown at step 412, or unique elasticities are developed, as shown at step 416, a long term Mortgage Service Rights (“MSR”) and recapture benefit—i.e., the amount of value recaptured by the continuing relationship with the customer—is built at step 418. One metric that may be used to determine recapture benefit according to the invention is the amount of customers who refinance their mortgage with the bank

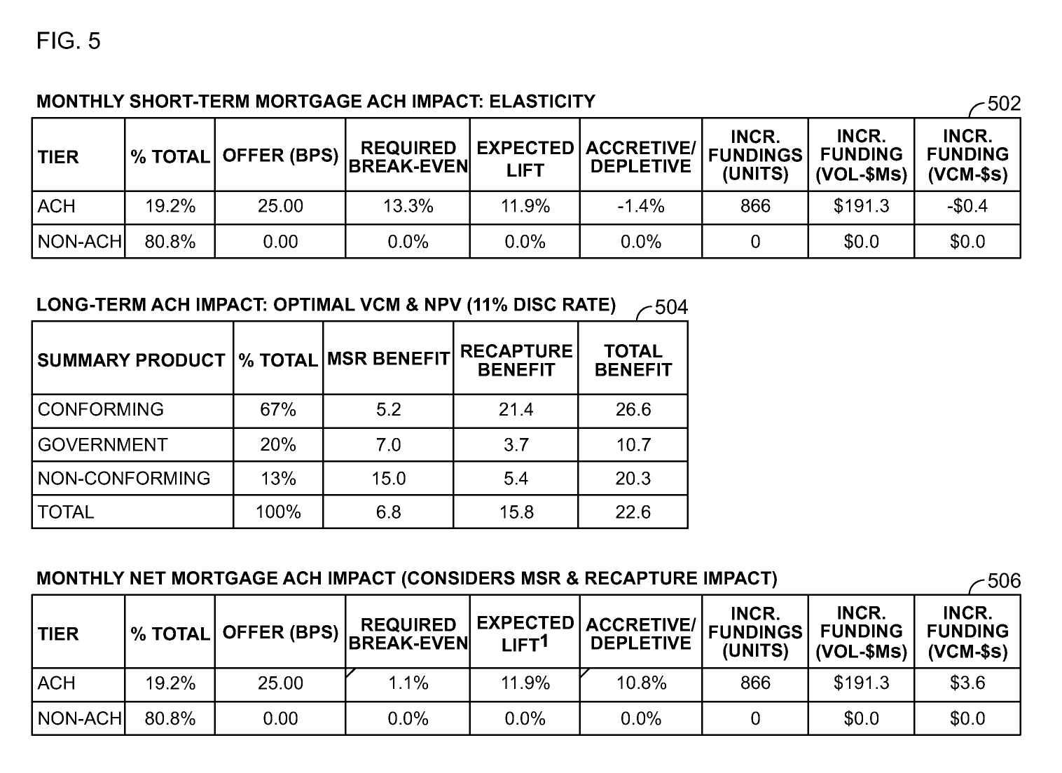

For the purpose of the exemplary hypothesis set forth in more detail with respect to FIGS. 5-7—i.e., whether customers with mortgage ACH perform better than non-ACH customers with respect to conditional pre-payment rate (“CPR”), delinquency, recapture and relationship deepening—recapture benefit—i.e., whether mortgage ACH has a relationship deepening effect that offsets possible losses attributable to discounts—may be calculated as follows:

(ACH Recapture/Non-ACH Recapture−1)×(Optimal VCMs).

While this application is directed to the aformentioned hypothesis regarding ACH, it should be noted that the systems and methods set forth in this application may also be implemented on other hypotheses such as a relationship continuum hypothesis (customers with assets or a primary relationship are more likely to deepen the relationship than customers without assets or a primary relationship), First Time Home Buyers (“FTHB”) are not price sensitive but will perform better from a pull-through, retention, and product deepening perspective than non-FTHBs, FTHBs behave more favorably in terms of prepayment speed, delinquency, foreclosure, and retention performance, and/or depth and tenure hypothesis (customers with depth and tenure are less price sensitive, but perform better in terms of prepayment speeds, delinquencies and retention).

An cost/benefit analysis, based on the long term MSR and the recapture developed at step 418, may be prepared at step 420, and finalized at step 422.

It should be noted that the MSR is affected by three drivers: cost to service, prepayment speeds and foreclosure rates.

Furthermore, a weighted average life for ACH customers is tabulated based on existing information, and the calculated NPV of the future recapture benefit assumes, in this exemplary embodiment, an 11% discount rate for recapture. Furthermore, the recapture is discounted, in this exemplary embodiment, using 6.58% average life assumption for ACH customers (MSR allocation is already expressed as NPV) and then the NPV is built into net cost/benefit analysis.

In FIGS. 5-7, an exemplary hypothesis is analyzed according to the steps set forth in FIGS. 2-4. The exemplary hypothesis relates to determining whether customers with mortgage automatic clearing house (“ACH”) payment perform better than non-ACH customers in terms of CPR, delinquency, recapture and relationship deepening—i.e., increased product use with the financial institution.

A first objective of an exemplary hypothesis analysis according to the invention is to determine whether customers with mortgage ACH perform better than non-ACH customers with respect to CPR, delinquency, recapture and relationship deepening.

As a further enhancement of the hypothesis evaluation, specifically with respect to price optimization, the exemplary analysis determines the financial impact of offering an ACH pricing discount. The analysis considers the short-term impact from a pricing discount, the long-term MSR effect and the recapture impact.

The relationship analytics guiding principles preferably require that approaches that are not revenue accretive to the Home Loans portion of an entity should preferably be revenue accretive for the entity as a whole. Accordingly, the analysis requires a measurement of the impact on both the Home Loans portion of the entity as well as the impact on the entity as a whole.

In addition, the analysis preferably determines, and leverages, a clear set of metrics to determine success of the hypothesis.

One core issue to be determined in connection with the exemplary hypothesis is whether the existence of ACH drives better performance. In other words, the question is does the ACH cause better customer performance, or does the ACH merely correlate with better customer performance.

In one example of the invention in practice, the initial validation of the hypothesis attempts to eliminate borrower profile as a factor in the results.

To control for profiles, the MSR allocation should preferably be prepared for loans with similar Loan to Value (“LTV”), Fair Isaac Corporation (“FICO”), and Debt to Income (“DTI”) bands.

In one testing of the hypothesis, the MSR effect was determined to be similar between a loan subset characterized by a single loan type and overall. This similarity indicates that loan profile most likely is also not the driver of observed differences.

With respect to a final validation of the hypothesis, a secondary quantization research group was utilized.

As part of the final validation, a separate regression analysis was performed for: 1) ACH and delinquencies; 2) ACH and prepayment speeds; and 3) ACH and recapture.

To isolate the effect of ACH, other variables that might also be predictive were modeled by suitable methods. Other variables may include LTV, DTI, Age, Tenure, Number of Products and/or online banking.

The hypothesis analysis determined that the ACH variable is a highly significant predictor of performance. As compared to customers without Mortgage ACH, a customer with ACH is:

Less likely to be delinquent on his or her mortgage;

Less likely to prepay his or her mortgage; and

More likely to remain with the financial institution after payoff of existing mortgage.

FIG. 5 shows illustrative tables in accordance with the principles of the invention.

FIG. 5 includes three tables. Table 502 shows the short-term impact on customer enrollment in an ACH-mortgage payment plan of a 25.00 basis points (“bps”) reduction in interest rate in return for a customer signing up for ACH-mortgage payments.

In this particular table, 19.2% of customers took the monthly short-term mortgage ACH offer. 80.8% of customers remained non-ACH customers.

The required break-even amount for the offer was 13.3% which was exceeded by the respondents. The expected lift—i.e., the expected amount of volume increase based on the discount offer—was 11.9%. In the short term, the offer was depletive of income from mortgages by 1.4%. The incremental funding was 866 Units—i.e., number of customers that enrolled. The incremental funding was 191.3 million dollars in order to make up for the short fall created by the depletion in income. The incremental funding for the VCMs is −$0.4.

Table 504 shows the long-term impact of an ACH offer. Table 504 is split into three component loans: conforming—i.e., loans conforming to government sponsored enterprise guidelines, such as Freddie Mac and Fannie Mae, non-conforming and government-backed loans. The total benefit, with respect to MSR benefit and recapture benefit, obtained is 22.6 units.

Table 506 shows the monthly net mortgage ACH impact (which considers MSR and Recapture Impact). Table 504 nets the short-term mortgage ACH impact, shown in table 502, against the long-term mortgage ACH impact, shown in table 504. From table 506, it can be seen that there is an accretive difference of 10.8% net impact and increased funding of VCM of about $3.6.

Based on the results of the analytics and regression analysis, it appeared that Mortgage ACH is a significant predictor of delinquency, prepayment speed, and recapture performance. While a 25 bps ACH discount is expected to be slightly depletive from a short-term perspective, the offer is expected to be accretive when accounting for the long-term MSR and recapture benefits. In the exemplary embodiments described herein, key risks that have not been accounted for by the hypothesis testing include gaming of ACH and change in mix of the offer population that could impact future performance.

Based on illustrative components of MSR allocation in an analysis according to the principles of the invention, it was determined that customers with mortgage ACH have slower prepayment speeds, lower delinquencies and lower costs to service than customers without mortgage ACH. Specifically, customers with mortgage ACH have 27% slower prepayment speeds, 86% lower foreclosure rates and 82% lower 90+ day delinquency rates.

A further exemplary hypothesis relates to determining whether there is a difference between recapture rates of mortgage ACH customers and recapture rates of non-mortgage ACH customers. It was determined that based on dollar volume, customers with mortgage ACH have 15% higher recapture rates than those without mortgage ACH. Furthermore, customers with mortgage ACH nave materially lower payoff rates than those without.

Additional observations that were obtained in the testing of the exemplary hypotheses was that new customers with induced ACH mortgage according to the hypothesis—i.e., the ACH payments were induced responsive to a reduction in interest rate—deepen a relationship with the institution at a greater rate than other customers. Already-existing customers that enter into an induced ACH mortgage deepen at a far greater rate than customers without sin induced ACH mortgage. Finally, existing customers with induced ACH exhibit slightly higher non-mortgage attrition than other customers.

Additional general observations regarding the ACH mortgage include the fact that customers that applied for the ACH generally have a stronger credit profile than customers without mortgage ACH, when considering such factors as LTV, FICO and DTI. From a product perspective, customers with mortgage ACH have a higher concentration of conforming products, whereas the non-ACH customers have a higher mix of government products.

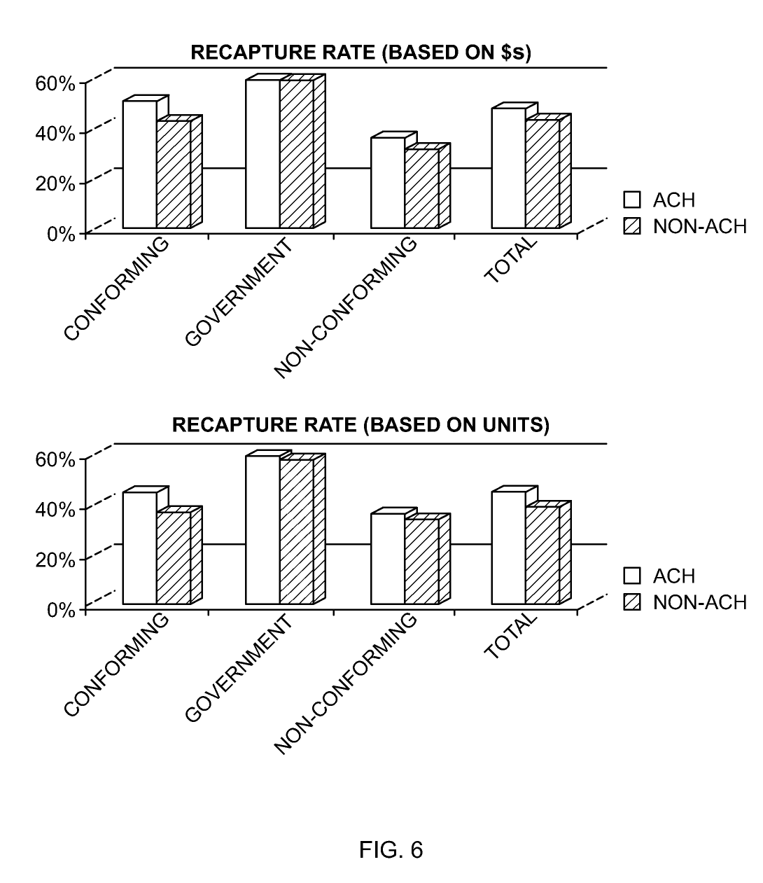

FIG. 6 shows an illustrative table 602 of relationship criteria in accordance with the principles of the invention. Such relationship criteria may include determining whether the hypothesis is directed toward subject matter associated with an enterprise initiative, whether minimal regulatory barriers exist for the hypothesis, what is the incremental revenue impact of the hypothesis (considering incremental discounts associated with moving forward), what is the relationship deepening effect associated with the hypothesis, what is the volume impact of the hypothesis, what is the customer impact of the hypothesis, what is the impact to low to moderate income concentration segments (“LMI”), the ease of implementation of the hypothesis, the impact to sales force of the hypothesis and the impact to capacity/fulfillment of the hypothesis. Other suitable relationship criteria may also be used to measure the importance of the selected hypothesis. Once a hypothesis is measured, then, to the extent that a hypothesis scores higher, it will be ranked higher.

FIG. 6 shows bar charts that illustrate the difference in recapture rate of ACH mortgage with the recapture rate of non-ACH mortgage.

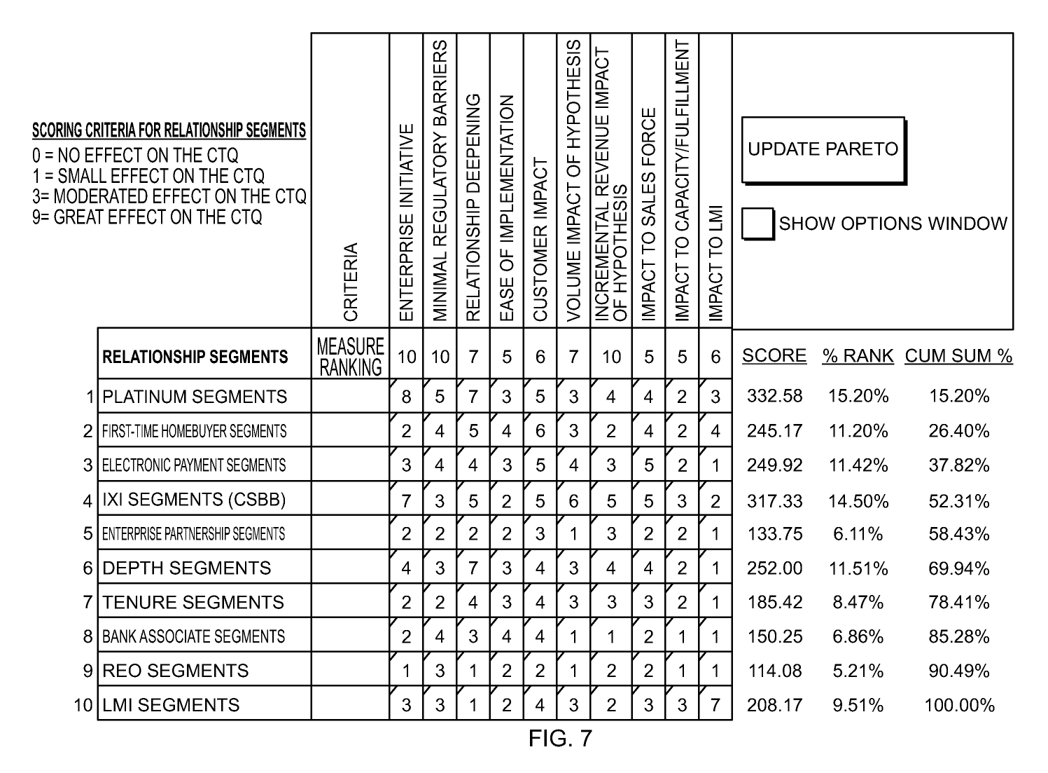

FIG. 7 shows an illustrative relationship segments prioritization matrix 702 to determine a hypothesis hierarchy relating to relationship segments prioritization results in accordance with the principles of the invention. In some embodiments of the invention, matrix 702 provides the user with the most productive segments for implementation of the hypothesis.

FIG. 7 includes the exemplary relationship criteria set forth along the x-axis and various relationship segments set forth along the y-axis. The relationship segments may include platinum segments, first-time homebuyer segments, electronic payment segments, third, party mass marketing segments (such as third party mass affluent segments, that have significant assets but not with a selected institution), enterprise partnership segments, depth segments, tenure segments, bank associate segments, real estate owned (“REO”) segments and LMI segments.

Based on table 702, each of the various segments was ranked. The information input is based on exemplary responses to surveys. Such survey responses may be obtained by distributing a blank template to a number of participants. The participants may score the survey according to a 0, 1, 3, 9 scale as defined in the top left of FIG. 7.

One objective of the surveys is to get a cross-functional perspective of the surveyed segments. Systems and methods according to the invention preferably include the matrix as part of a process for prioritization and analysis of hypotheses across a broad spectrum of population segments. The exemplary outcome of the matrix ranks platinum segments the highest and real-estate owned (“REO”) segments the lowest; but other rankings are possible, dependent upon differing survey outcomes and different segment weightings.

Once the rankings have been determined, the results of the rankings may guide the further, more in-depth, testing of the hypothesis and/or the implementation of a business plan based on a successful hypothesis.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

Thus, systems and methods for providing a relationship-pricing measurement framework have been provided. Persons skilled in the art will appreciate that the present invention can be practiced by other than the described embodiments, which are presented for purposes of illustration rather than of limitation. The present invention is limited only by the claims that follow.

What is claimed is:

1. Apparatus for providing a hypothesis prioritization and analysis tool, the apparatus comprising:
an electronic input module for:
receiving a plurality of criteria relating to characteristics of a hypothesis;
receiving a predetermined weight for each of the criteria;
receiving a list of relationship segments;
an electronic processing module for:
determining a value for each of the relationship segments with respect to each of the plurality of criteria, said determining being based, at least in past, on the predetermined weight for each of the criteria;
summing the determined values for each of the relationship segments; and
ranking each of the relationship segments with respect to one another based on the summing of the determined values for each of the relationship segments.

2. The apparatus of claim 1 further comprising an electronic output module for outputting ranked relationship segments based at least in part on the ranking.

3. The apparatus of claim 1 wherein the predetermined weight for each of the criteria is determined based on survey results.

4. The apparatus of claim 1, wherein the list of relationship segments is divided among socio-economic stratum.

5. The apparatus of claim 1, wherein the hypothesis relates to whether customers who pay mortgage payments by ACH perform better than customers who do not pay mortgage payments by ACH.

6. The apparatus of claim 5, wherein the analysis of the hypothesis further comprises determining the ratio of the recapture rate for customers who pay mortgage payments by ACH to the recapture rate for customers who do not pay mortgage payments by ACH.

7. The apparatus of claim 6 wherein the determining of the recapture rate is calculated using the following formula:
(ACH Recapture/Non-ACH Recapture−1)×(Optimal VCMs).

8. The apparatus of claim 5, wherein the analysis of the hypothesis further comprises comparing the mortgage service rights for customers who pay mortgage payments by ACH to the mortgage service rights for customers who do not pay mortgage payments by ACH.

9. The apparatus of claim 6, wherein the analysis of the hypothesis further comprises comparing a metric associated with relationship deepening for customers who pay mortgage payments by ACH to the same metric associated with relationship deepening for customers who do not pay mortgage payments by ACH.

10. The apparatus of claim 1 wherein the criteria comprise at least five criteria selected from the following criteria: whether the hypothesis relates to an enterprise initiative, whether minimal regulatory barriers exist for the hypothesis, whether the hypothesis is capable of promoting customer relationship deepening, the ease of implementation of the hypothesis, the customer impact of the hypothesis, the volume impact of the hypothesis, the incremental revenue impact of the hypothesis, the sales force impact of the hypothesis, and the impact to capacity of the hypothesis.

11. Apparatus for providing a hypothesis prioritization and analysis tool, the apparatus comprising:
an electronic input module for:
receiving a plurality of criteria relating to characteristics of a hypothesis, wherein the hypothesis relates to whether customers who pay mortgage payments by ACH perform better than customers who do not pay mortgage payments by ACH.
receiving a predetermined weight for each of the criteria;
receiving a list of relationship segments;
an electronic processing module for:
determining a value for each of the relationship segments with respect to each of the plurality of criteria, said determining being based, at least in part, on the predetermined weight for each of the criteria;
summing the determined values for each of the relationship segments; and
ranking each of the relationship segments with respect to one another based on the summing of the determined values for each of the relationship segments
wherein the criteria include a plurality of criteria selected from the following criteria: whether the hypothesis relates to an enterprise initiative, whether minimal regulatory barriers exist for the hypothesis, whether the hypothesis is capable of promoting customer relationship deepening, the ease of implementation of the hypothesis, the customer impact of the hypothesis, the volume impact of the hypothesis, the incremental revenue impact of the hypothesis, the sales force impact of the hypothesis, and the impact to capacity of the hypothesis.

12. The apparatus of claim 10 further comprising an electronic output module for outputting ranked relationship segments based at least in part on the ranking.

13. The apparatus of claim 10 wherein the predetermined weight for each of the criteria is determined based on survey results.

14. The apparatus of claim 10, wherein the list of relationship segments is divided, at least in part, among socio-economic stratum.

15. The apparatus of claim 14, wherein the analysis of the hypothesis further comprises comparing the recapture rate for customers who pay mortgage payments by ACH to the recapture rate for customers who do not pay mortgage payments by ACH.

16. The apparatus of claim 15, wherein the determining of the recapture rate is calculated using the following formula:
(ACH Recapture/Non-ACH Recapture−1)×(Optimal VCMs).

17. The apparatus of claim 15, wherein the analysis of the hypothesis further comprises comparing the mortgage service rights for customers who pay mortgage payments by ACH to the mortgage service rights for customers who do not pay mortgage payments by ACH.

18. The apparatus of claim 15, wherein the analysis of the hypothesis further comprises comparing a metric associated with relationship deepening for customers who pay mortgage payments by ACH to the metric associated with relationship deepening for customers who do not pay mortgage payments by ACH.
